(19) United States
(12) Patent Application Publication
(10) Pub. No.: US 2011/0002286 A1
(43) Pub. Date: Jan. 6, 2011

(54) METHOD AND APPARATUS FOR ALLOCATING DATA BURST

(75) Inventors: Hyung Joon JEON, Seongnam-si (KR); Jun Seong Park, Seongnam-si (KR); Jae Hyeong Kim, Seoul (KR)

Correspondence Address: BLANK ROME LLP, WATERGATE, 600 NEW HAMPSHIRE AVENUE, N.W., WASHINGTON, DC, 20037, US

(73) Assignee: POSDATA CO., LTD, Kyeonggi-do (KR)

(21) Appl. No.: 12/823,502

(22) Filed: Jun. 25, 2010

(30) Foreign Application Priority Data
Dec. 26, 2007 (KR) 1020070137536
Dec. 28, 2007 (KR) 1020070140788

(51) Int. Cl. H04W 72/04

(52) U.S. Cl. 370/329; 370/344

(57) ABSTRACT

A method and apparatus for allocating a data burst is disclosed, which is capable of differently setting a start symbol offset, at which an allocation of data burst is started, by each sector when allocating the data burst into a downlink sub-frame for each of neighboring sectors, wherein the method is comprised of dividing a data region of a downlink sub-frame for each of neighboring sectors into a plurality of segment regions, and allocating each of the segment regions into the respective sectors without being overlapped; and allocating downlink data bursts for the respective sectors, wherein the allocation of downlink data bursts is sequentially started from the segment region allocated for each sector.

### CROSS-REFERENCE TO RELATED APPLICATIONS

The present application is a National Phase of PCT/KR2008/007721, filed Dec. 26, 2008, which claims the benefit of Korean Application Nos. 1020070137536, filed Dec. 26, 2007 and 1020070140788 filed Dec. 28, 2007. The disclosures of the above-referenced applications are hereby incorporated by reference in their entireties into the present disclosure.

### TECHNICAL FIELD

The present invention relates to a method for allocating a data burst in a wireless communication system, and more particularly, to a method and apparatus for allocating a data burst, which is capable of minimizing interference among neighboring sectors in a wireless communication system.

### BACKGROUND ART

A broadband wireless access system (hereinafter, referred to as ‘BWA’) using an orthogonal frequency division multiplexing access scheme (hereinafter, referred to as ‘OFDMA’), which is a communication system proposed by IEEE (Institute of Electrical and Electronics Engineers) 802.16, can transmit a large amount of data for a short period of time owing to its broad bandwidth, and can improve the efficiency in use of channel since all users share the channel in common.

In the BWA, a base station allocates Subchannels for each user in each uplink frame and downlink frame and allocates the bursts for each users using the subchannels in each frame.

The uplink and downlink access information with the burst allocation information is provided to each user.

FIG. 1 illustrates downlink sub-frame structure in a general IEEE 802.16d/e communication system. As shown in FIG. a downlink sub-frame 100 has the horizontal axis defined as the symbol axis, and the vertical axis defined as the frequency axis. The downlink sub-frame 100 is comprised of a preamble region 110, a MAP region 120, and a data region 130.

The preamble region 110 transmits a synchronization signal for a synchronization acquisition between the base station and mobile stations, that is, a downlink preamble sequence. The MAP region 120 transmits a downlink MAP message and an uplink MAP message. The data region 130 transmits a plurality of downlink data bursts which target the mobile stations.

At this time, the downlink data bursts are allocated to a two-dimensional region (or resource) defined with time and frequency within the data region. In more detail, when the data burst is allocated into the downlink data region, the data burst is allocated to a quadrangle defined with a symbol offset, a sub-channel offset, the number of used symbols, and the number of used sub-channels.

In the related art for allocating the data burst, the data burst is allocated in a vertical manner. Thus, the data burst is allocated until completing the allocation of data burst for all sub-channels in a predetermined symbol duration. After completing the allocation of data burst for all sub-channels, the allocation of data burst is started again from the first sub-channel of the next symbol duration.

However, the related art for allocating the data burst in the vertical manner has a problem of interference among the neighboring sectors even if the downlink sub-frame is not fully loaded. This is because the data burst is allocated in the vertical manner from the same symbol offset of the respective sectors, in case of the neighboring sectors shown in FIG. 2.

### DISCLOSURE

### Technical Problem

Therefore, the present invention has been made in view of the above problems, and it is an object of the present invention to provide a method and apparatus for allocating data bursts, which is capable of preventing one or more problems of the related art.

An object of the present invention is to provide a method and apparatus for allocating data bursts, which is capable of differently setting a start symbol offset, at which an allocation of data burst is started, by each sector when allocating the data bursts into a downlink sub-frame for each of neighboring sectors.

Another object of the present invention is to provide a method and apparatus for allocating data bursts, which is capable of using a method for allocating the data bursts in an increasing sub-channel direction together with a method for allocating the data bursts in an increasing symbol direction.

A further object of the present invention is to provide a method and apparatus for allocating data bursts, which is capable of determining a region to be allocated with the data bursts within a data region in consideration of a location of MS when allocating the data bursts.

### Technical Solution

To achieve these objects and other advantages and in accordance with the purpose of the invention, as embodied and broadly described herein, a method for allocating data bursts comprises dividing a data region of a downlink sub-frame for each of neighboring sectors into a plurality of segment regions, and allocating each of the segment regions into the respective sectors without being overlapped; and allocating downlink data bursts for the respective sectors, wherein the allocation of downlink data bursts is sequentially started from the segment region allocated for each sector.

The step for allocating the downlink data bursts is characterized by sequentially allocating the downlink data bursts in an increasing sub-channel direction within a predetermined symbol-duration. At this time, the symbol indicating a start of the data region and the number of symbols allocated into the data region are identically set in each sector. Also, the number of segment regions is determined according to the number of neighboring sectors.

The step for allocating the downlink data bursts is characterized by allocating the downlink data bursts into a region between the symbol indicating the start of the data region and a symbol indicating a start of the segment region allocated for each sector, if the downlink data bursts is allocated to the final symbol duration of the downlink sub-frame by each sector.

In addition, the method further comprises generating and allocating a downlink MAP message indicating the downlink data bursts and an uplink MAP message indicating an uplink data bursts in a MAP region of the downlink sub-frame. At this time, a region which remains in a MAP region of the downlink sub-frame after allocating a downlink MAP message and uplink MAP message is defined as a shared region, and the downlink data burst is additionally allocated into the shared region. Also, the downlink data bursts allocated into the shared region are the downlink data bursts for an MS of a higher SINR.

In one embodiment of the present invention, the method further comprises re-arranging downlink MAP IEs of downlink MAP message for each sector or packets corresponding to the downlink data bursts in a time-sequential order, if the downlink data bursts for each sector are not allocated in the time-sequential order after the step for allocating the downlink data bursts.

In the meantime, the method further comprises checking a location of MS, wherein, in the allocation of the downlink data bursts, if there is a request for the additional allocation of the downlink data bursts after completing the allocation of the downlink data bursts in the segment region allocated for each sector, the segment region to be additionally allocated with the downlink data bursts is determined in consideration of the location of MS and the downlink data bursts is additionally allocated into the determined segment region.

Also, the step for allocating the downlink data bursts further comprising defining a shared region in the data region by allocating an additional zone in the data region, wherein the downlink data bursts for the MS of the higher SINR is allocated into the shared region.

In one embodiment of the present invention, the step for allocating the downlink data bursts comprises firstly allocating the downlink data bursts into the segment region allocated by each sector; and additionally allocating the downlink data bursts in an increasing symbol direction within the other segment region, sequentially, except for the segment region allocated by each sector, if there is a request for the additional allocation of the downlink data bursts after completing the allocation of the downlink data bursts in the segment region allocated by each sector. At this time, the step for firstly allocating the downlink data bursts is characterized by sequentially allocating downlink data bursts in the increasing sub-channel direction or increasing symbol direction.

In another aspect of the present invention, a method for allocating data bursts comprises differently setting a start symbol offset for allocation of the downlink data bursts in a downlink sub-frame for each of neighboring sectors by each sector; and allocating the downlink data bursts for the respective sectors based on the start symbol offset differently set by each sector.

At this time, the step for allocating the downlink data bursts comprises firstly allocating the downlink data bursts into a prior-allocation region including a predetermined number of symbols from the start symbol offset allocated by each sector; and additionally allocating the downlink data bursts in an increasing symbol direction within the other regions, sequentially, except for the prior-allocation region if there is a request for an additional allocation of the downlink data bursts after completing the prior allocation of the downlink data burst.

In another aspect of the present invention, an apparatus for allocating data bursts comprises a means for differently setting a symbol offset to indicate a start of allocation of downlink data bursts in a data region of a downlink sub-frame for each of neighboring sectors by each sector; and a means for allocating the downlink data bursts for the respective sectors based on the start symbol offset differently set by each sector.

At this time, the means for allocating the downlink data bursts comprises a means for firstly allocating the downlink data bursts into a prior-allocation region including a predetermined number of symbols from the start symbol offset allocated by each sector; and a means for additionally allocating the downlink data bursts into the other regions, sequentially, except for the prior-allocation region if there is a request for an additional allocation of the downlink data bursts after firstly allocating the downlink data bursts.

In another aspect of the present invention, a method for allocating data bursts comprises setting start symbol offset of a first sector which is different from start symbol offsets of at least two neighbor second sectors in a data burst region of a downlink sub-frame of the first sector; and allocating data bursts into a vertical burst allocation region defined by the number of first OFDMA symbols from the start symbol offset for the first sector.

In addition, the method further comprises allocating additional data bursts into a horizontal burst allocation region defined by the number of second OFDMA symbols within the other region of the data burst region of the downlink sub-frame except for the vertical burst allocation region.

At this time, the downlink sub-frame includes a shared region into which data bursts is allocated for all sectors.

### ADVANTAGEOUS EFFECTS

According to the present invention, the start symbol offset, at which the allocation of data bursts is started, is differently set by each sector for allocation of the data bursts into the downlink sub-frame for each of neighboring sectors, thereby resulting in reduction of interference among the respective sectors. On allocation of the data bursts, the data bursts are allocated in the increasing sub-channel direction within the prior-allocation region set by each sector, and the data bursts are allocated in the increasing symbol direction within the other regions except for the prior-allocation region. Thus, it is possible to reduce the interference among the respective sectors even though there is a large loading by each sector.

On allocation of the data bursts, the region to be allocated with the data bursts within the data region is determined in consideration of the location of MS, whereby resource can be allocated to each MS under the reduced interference among the respective sectors.

### DESCRIPTION OF DRAWINGS

FIG. 1 illustrates a downlink sub-frame structure in a general wireless communication system.

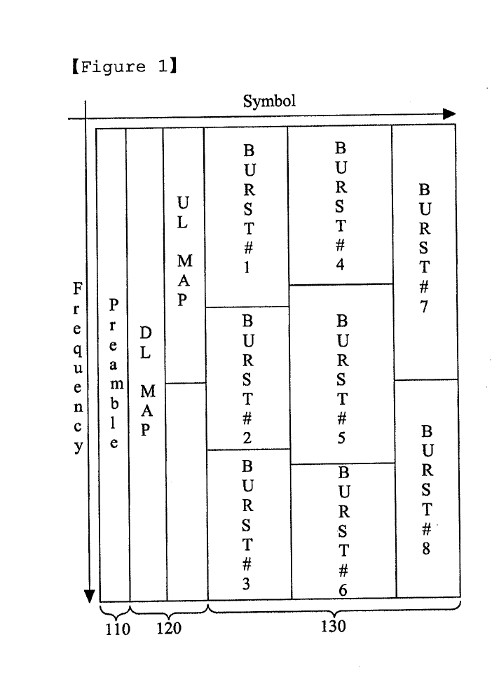

FIG. 2 illustrates interference generated among neighboring sectors.

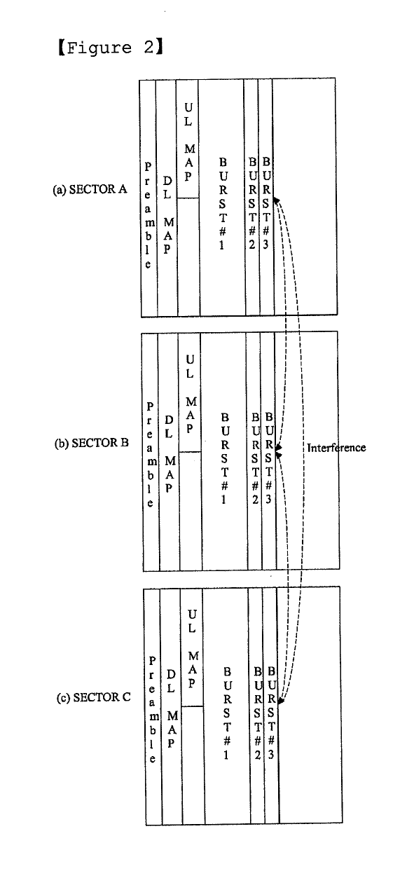

FIG. 3 is a block diagram illustrating an apparatus for allocating data bursts according to the first embodiment of the present invention.

FIG. 4 illustrates one exemplary method for determining a symbol offset for each sector according to the present invention.

FIG. 5 illustrates a downlink frame structure for each sector allocated with data bursts according to the first embodiment of the present invention.

FIG. 6 illustrates a method for setting a shared region in a data region through the use of zone switch.

FIG. 7 illustrates a method for determining data bursts allocation region in consideration of a location of MS in a neighboring sector.

FIG. 8 is a flowchart illustrating a method for allocating data bursts according to the first embodiment of the present invention.

FIG. 9 is a block diagram illustrating an apparatus for allocating data bursts according to the second embodiment of the present invention.

FIG. 10 illustrates a downlink frame structure for each sector allocated with data bursts according to the second embodiment of the present invention.

FIG. 11 is a flowchart illustrating a method for allocating data bursts according to the second embodiment of the present invention.

### MODE FOR INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a method and apparatus for allocating a data burst in a wireless communication system according to the present invention will be explained with reference to the accompanying drawings.

### First Embodiment

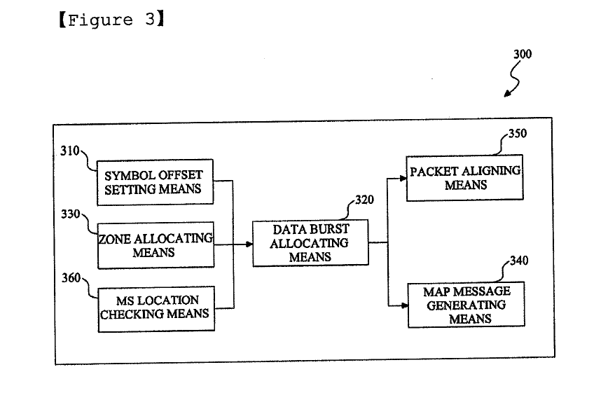

FIG. 3 is a block diagram schematically illustrating an apparatus for allocating data bursts according to the first embodiment of the present invention. The apparatus for allocating the data bursts 300 shown in FIG. 3 can allocate downlink data bursts within a downlink sub-frame in a vertical direction, that is, an increasing sub-channel direction. As shown in FIG. 3, the apparatus for allocating the data bursts 300 includes a symbol offset setting means 310, a data burst allocating means 320, a zone allocating means 330, a MAP message generating means 340, and a packet aligning means 350.

The symbol offset setting means 310 sets a start symbol offset (hereinafter, referred to as ‘symbol offset’), at which an allocation of a downlink data burst (hereinafter, referred to as ‘data burst’) is started, within a data region of a downlink sub-frame. In one embodiment of the present invention, the symbol offset setting means 310 differently sets the symbol offset for each of neighboring sectors in the data region, wherein the symbol offset indicates a point at which the allocation of the data burst is started.

Preferably, both the symbol indicating a start of the data region in the downlink sub-frame and the number of symbols allocated into the data region are identically set in each sector.

In order to differently set the symbol offset for each sector, the symbol offset setting means 310 divides the data region of the downlink sub-frame into a plurality of segment regions. In one embodiment of the present invention, the number of segment regions can be determined according to the number of neighboring sectors. In the general wireless communication system, one cell is divided into three sectors, that is, the number of segment regions can be set as ‘3’.

Then, the symbol offset setting means 310 allocates each of the plurality of segment regions into the respective sectors without being overlapped.

The symbol at which the segment region allocated for each sector is started is determined as the symbol offset for each sector. Through this procedure, the symbol offset setting means 310 can differently set the symbol offset for each sector, at which the allocation of the data burst is started.

At this time, the symbol at which each segment region is started can be determined by the following equation 1.

$${S}_{i} = {S}_{d} + ( \frac{{N}_{d}}{{N}_{s}} \times i ) \qquad [ Equation 1 ]$$

wherein, Sᵢ indicates the symbol at which each i-th segment region is started, S_{d} indicates the symbol at which the data region is started, N_{d} indicates the number of symbols allocated into the data region, Nₛ indicates the number of neighboring sectors, and i indicates the number granted to each segment region. In one embodiment of the present invention, if the data region is divided into the three segment regions, i is defined as ‘0’ to ‘2’.

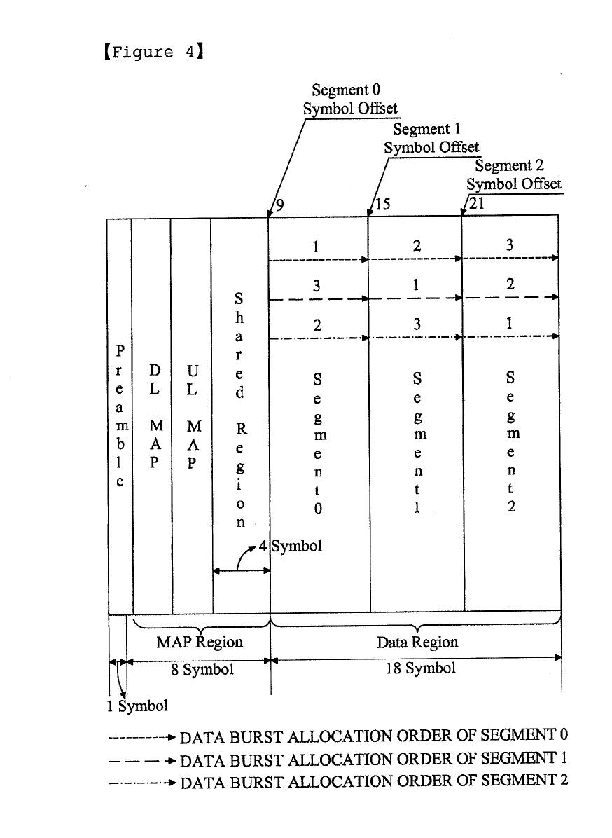

A method for setting the symbol offset by the symbol offset setting means 310 will be described with reference to FIG. 4. In FIG. 4, the downlink sub-frame is composed of twenty-seven symbols, one symbol is allocated into a preamble, eight symbols are allocated into a MAP region, and eighteen symbols are allocated into the data region. Supposing that the number of neighboring sectors is three (A, B, and C). In this case, as shown in FIG. 4, the data region can be divided into the three segment regions, and the symbol index at which each segment region is started can be calculated by the above equation 1.

1) segment region 0: symbol 9

2) segment region 1: symbol 15

3) segment region 2: symbol 21

In this case, on assumption that the segment region 0 is allocated for the sector A, the segment region 1 is allocated for the sector B, and the segment region 2 is allocated for the sector C; the symbol offset of sector A is set as the symbol 9 at which the segment region 0 is started, the symbol offset of sector B is set as the symbol 15 at which the segment region 1 is started, and the symbol offset of sector C is set as the symbol 21 at which the segment region 2 is started.

The aforementioned embodiment of the present invention discloses that the segment region 0 is allocated for the sector A, the segment region 1 is allocated for the sector B, and the segment region 2 is allocated for the sector C. However, this is only example, that is, the segment region allocated for each sector may be changed.

Through the aforementioned procedure, the symbol offset at which the allocation of the data burst is started is differently set for each sector.

Referring once again to FIG. 3, the data burst allocating means 320 allocates the data bursts in the data region, and more particularly, starts to allocate the data bursts from the symbol offset of each sector. That is, the data burst allocating means 320 allocates the data bursts at the symbol offset differently set for each sector. At this time, the size of the data burst is determined in consideration of a size of the data to be transmitted or a channel state.

In one embodiment of the present invention, the data burst allocating means 320 allocates the data bursts in a vertical direction. As mentioned above, the vertical data burst allocation indicates that the data bursts is allocated in the increasing sub-channel direction within a predetermined symbol duration, and then the data bursts is sequentially allocated again in the increasing sub-channel direction from an initial sub-channel of the next symbol duration after the allocation of the data bursts is completed in the predetermined symbol duration.

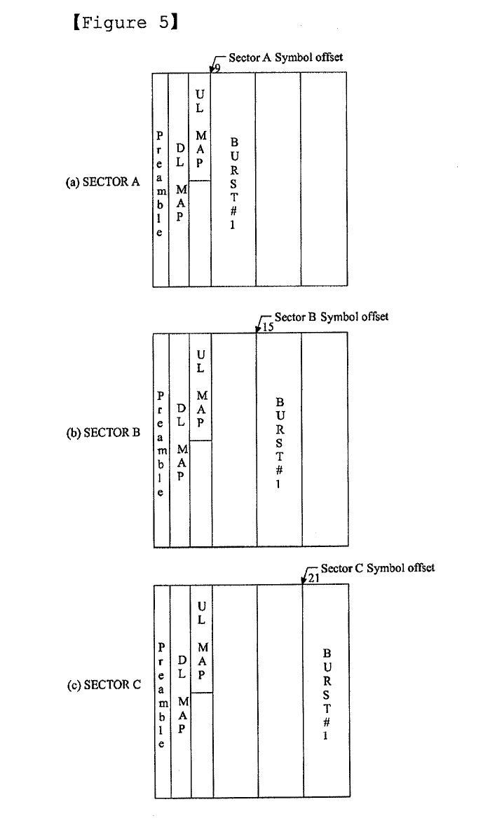

A procedure for allocating the data bursts will be explained in detail. For example, in the example of FIG. 5, the symbol offset of sector A is the symbol 9, the symbol offset of sector B is the symbol 15, and the symbol offset of sector C is the symbol 21. Thus, as shown in FIG. 5, the means data burst allocating means 320 starts to vertically allocate the data burst #1 from the symbol 9 in the sector A, to vertically allocate the data burst #1 from the symbol 15 in the sector B, and to vertically allocate the data burst #1 from the symbol 21 in the sector C.

According to the present invention, the allocation of data burst is started at the different region by each sector, thereby resulting in reduction of interference among the respective sectors.

On allocation of the data bursts for each sector, if there is the remaining data to be allocated after the data bursts are allocated to the final symbol of the data region, the data burst allocating means 320 can re-allocate the data bursts into the region between the symbol at which the data region is started and the symbol offset for each sector.

For example, in case of the sector B for which the segment region 1 is allocated, if the data to be allocated remains even after allocating the data bursts to the final symbol of the data region, the data burst allocating means 320 can re-allocate the data bursts into the region between the symbol 9 at which the data region is started and the symbol 15 corresponding to the symbol offset of sector B.

In case of the sector C for which the segment region 2 is allocated, if the data to be allocated remains even after allocating the data bursts to the final symbol of the data region, the data burst allocating means 320 can re-allocate the data bursts into the region between the symbol 9 at which the data region is started and the symbol 21 corresponding to the symbol offset of sector C.

That is, as shown in FIG. 4, the data burst allocating means 320 allocates the data bursts in the order of segment region 0, segment region 1, and segment region 2 in case of the sector A; allocates the data bursts in the order of segment region 1, segment region 2, and segment region 0 in case of the sector B; and allocates the data bursts in the order of segment region 2, segment region 0, and segment region 1 in case of the sector C.

In the meantime, if there is the remaining region after allocating downlink and uplink MAP messages into the MAP region of the downlink sub-frame by the MAP message generating means 340, the data burst allocating means 320 can set the corresponding region as a shared region, and can additionally allocate the data bursts into the shared region.

For example, as shown in FIG. 4, if the MAP region of the downlink sub-frame is set as 8-symbol duration, and the downlink and uplink MAP messages are allocated into the 4 symbols among the 8 symbols; the data burst allocating means 320 sets the remaining 4-symbol duration of the MAP region as the shared region, and additionally allocates the data bursts into the shared region.

All sectors allocate the data burst into the shared region, whereby it may cause severe interference among the sectors. In this respect, preferably, the shared region is allocated with the data burst for a corresponding MS of the highest SINR (Signal to Interference Noise Ratio) among the plurality of MSs located in each sector.

The aforementioned embodiment of the present invention discloses that the remaining region of the MAP region, which is left after allocating the MAP message, is set as the shared region by the data burst allocating means 320. However, a modified embodiment of the present invention may disclose that some of the data region is set as the shared region.

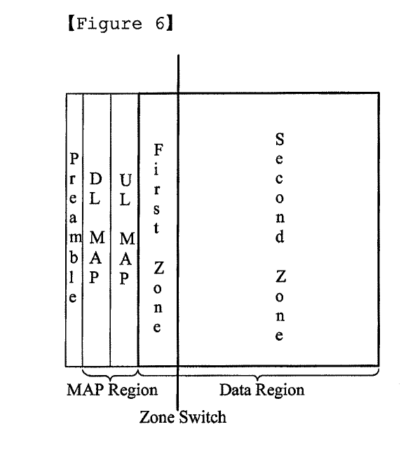

For this, the apparatus for allocating the data burst 300 may further include the zone allocating means 330. In one embodiment of the present invention, as shown in FIG. 6, the zone allocating means 330 divides the data region into first and second zones through the use of zone switch, wherein the first zone is set as the shared region, and the second zone is set as the region allocated with the data bursts.

At this time, as mentioned above, the shared region is allocated with the data burst for the corresponding MS of the highest SINR among the plurality of MSs located in each sector.

Referring once again to FIG. 3, the MAP message generating means 340 generates the downlink MAP message (DL-MAP) and uplink MAP message (UL-MAP), and allocates the generated DL-MAP and UL-MAP messages into the MAP region of the downlink sub-frame. At this time, the DL-MAP message includes information indicating that the downlink data bursts transmitted from a BS belong to whom (to which user data) and indicating where the downlink data bursts transmitted from the BS are located in the downlink sub-frame. Also, the UL-MAP message includes information about the uplink data bursts transmitted by the MSs.

Among the MAP messages, the DL-MAP message includes a DL-MAP information element (hereinafter, referred to as ‘DL-MAP IE’) defined with information about each data burst. In this case, the DL-MAP IE includes a modulation level of the data burst, a starting point of the data burst (symbol offset and sub-channel offset), a size of the data burst (the number of symbols and the number of sub-channels), and information about the MS to which the data burst is to be transmitted.

That is, the MAP message generating means 340 generates the MAP message to include the information about the data bursts allocated by the data burst allocating means 320 in the DL-MAP IE.

At this time, the MAP message generating means 340 arranges the MAP IEs corresponding to the data bursts in the MAP message according to the allocation order of the data bursts. However, in case of the present invention, the data bursts may not be allocated in the time-sequential order. In this case, there is a need to re-arrange the DL-MAP IEs included in the MAP message according to the time-sequential order by the MAP message generating means 340.

For example, in case of the sector B with reference to FIG. 4, the data burst is allocated in the order of segment region 1, segment region 2, and segment region 0. Eventually, the data burst is firstly allocated into the segment region 0 which is prior to any other segment regions.

Accordingly, in case of the sector B, the data bursts are not allocated according to the time-sequential order. Thus, the MAP message generating means 340 re-allocates the MAP IEs for all data bursts allocated into the data region according to the time-sequential order, whereby the MAP IEs for the data bursts allocated into the segment region 0 are firstly arranged in order of time.

That is, the MAP IEs are arranged in the order of MAP IEs for the data bursts in the segment region 0, MAP IEs for the data bursts in the segment region 1, and MAP IEs for the data burst in the segment region 2.

The aforementioned embodiment of the present invention discloses that only order of the MAP IEs for the respective data bursts is re-arranged when the data bursts are not allocated according to the time-sequential order. In order to improve the accuracy in data transmission, the order of packets corresponding to the data bursts as well as the order of MAP IEs should be re-arranged according to the time-sequential order. For this, the aforementioned apparatus for allocating the data burst 300 may further include the packet aligning means 350.

Meanwhile, in the aforementioned embodiment of the present invention, the data burst allocating means 320 firstly allocates the data bursts into the segment region allocated for each sector, and then allocates the data bursts in the time-sequential order after the allocation of the data bursts for the corresponding segment region is completed.

However, in a modified embodiment of the present invention, after completing the allocation of the data bursts in the segment region allocated for each sector, the data burst allocating means 320 may controllably determine the segment region to be allocated with the data bursts in consideration of the location of MS, instead of allocating the data bursts in the time-sequential order.

For this, the data burst allocating means 320 according to the present invention may further include a MS location checking means 360. At this time, each MS is equipped with a location-detecting device such as GPS (Global Positioning System), whereby the data burst allocating means 320 can check the location of each MS.

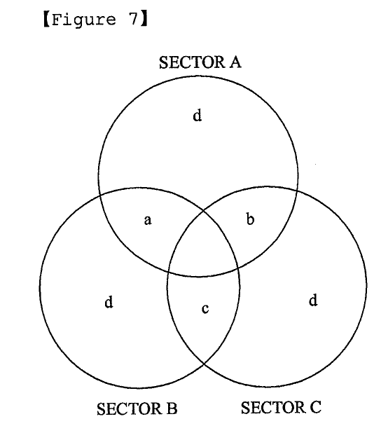

A detailed method for determining the segment region to be allocated with the data bursts in consideration of the location of MS will be described with reference to FIG. 7. Supposing that the segment region 0 is allocated for the sector A to be firstly allocated with the data bursts, the segment region 1 is allocated for the sector B, and the segment region 2 is allocated for the sector C.

First, if it is determined that the MS is located in an overlapped region (a) between the sector A and the sector B, the data burst allocating means 320 determines the segment region 2 as the corresponding segment region to be allocated with the data bursts after the completion of data bursts allocation in the segment region 0 of the sector A. This is because the allocation of data bursts shall be firstly started from the segment region 1 in case of the sector B.

In case of the sector B, the data burst allocating means 320 determines the segment region 2 as the corresponding segment region to be allocated with the data bursts after the completion of data bursts allocation in the segment region 1 since the allocation of data bursts shall be firstly started from the segment region 0 in case of the sector A.

Next, if it is determined that the MS is located in an overlapped region (b) between the sector A and the sector C, the data burst allocating means 320 determines the segment region 1 as the corresponding segment region to be allocated with the data bursts after the completion of data bursts allocation in the segment region 0 of the sector A. This is because the allocation of data bursts shall be started from the segment region 2 in case of the sector C.

In case of the sector C, the data burst allocating means 320 determines the segment region 1 as the corresponding segment region to be allocated with the data bursts after the completion of data bursts allocation in the segment region 2 since the allocation of data bursts shall be started from the segment region 0 in case of the sector A.

Next, if it is determined that the MS is located in an overlapped region (c) between the sector B and the sector C, the data burst allocating means 320 determines the segment region 0 as the corresponding segment region to be allocated with the data bursts after the completion of data bursts allocation in the segment region 1 of the sector B. This is because the allocation of data bursts shall be started from the segment region 2 in case of the sector C.

In case of the sector C, the data burst allocating means 320 determines the segment region 0 as the corresponding segment region to be allocated with the data bursts after the completion of data bursts allocation in the segment region 2 since the allocation of data bursts shall be started from the segment region 1 in case of the sector B.

Finally, if it is determined that the MS is located in a non-overlapped region (d) where the sectors are not overlapped, the data burst allocating means 320 determines the aforementioned shared region as the corresponding region to be allocated with the data bursts for the MS.

The aforementioned embodiment of the present invention discloses that the apparatus for allocating the data burst is comprised of the plurality of separate means. However, these separate means may be integrated as one means such as a scheduler of BS.

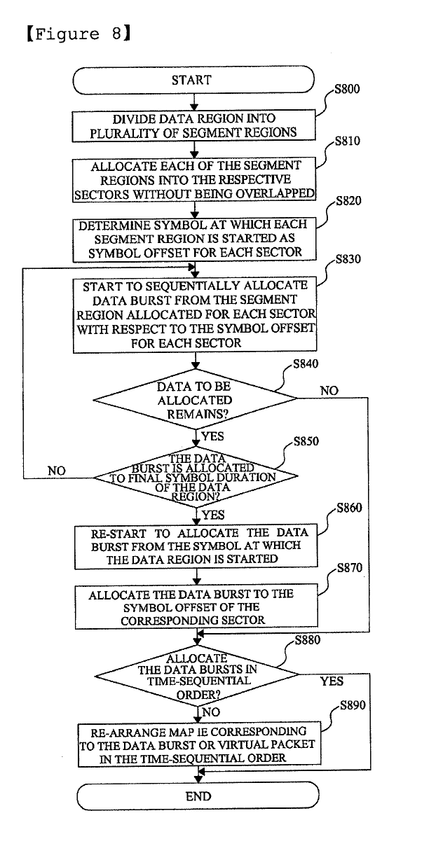

Hereinafter, a detailed method for allocating the data burst according to the first embodiment of the present invention will be described with reference to FIG. 8.

For differently setting the symbol offset for each sector, wherein the symbol offset indicates the point at which the allocation of the downlink data burst is started, the data region of the downlink sub-frame for each of the neighboring sectors is divided into the plurality of segment region along the symbol axis in step of S800. At this time, the number of segment regions is determined according to the number of neighboring sectors. In the wireless communication system according to one embodiment of the present invention, since one cell is divided into the three sectors, the number of segment regions is set as ‘3’.

Then, each of the segment regions is allocated into the respective sectors without being overlapped, in step of S810. For example, supposing that the neighboring sectors are three of A, B, and C; and the data region is divided into the segment region 0, the segment region 1, and the segment region 2. In this case, the segment region 0 is allocated for the sector A, the segment region 1 is allocated for the sector B, and the segment region 2 is allocated for the sector C.

After that, the symbol at which each segment region is started is determined as the symbol offset at which the data burst allocation for each sector is started in step of S820.

According as each of the segment regions is allocated for the respective sectors without being overlapped, and the location of symbol at which each segment region is started is determined as the symbol offset for each sector, the symbol offset can be differently set for each sector. At this time, the location of symbol at which each segment region is started can be determined by the aforementioned equation 1.

Then, the downlink data bursts are sequentially allocated from the segment region allocated for each sector based on the symbol offset for each sector in step S830. At this time, the downlink data bursts are allocated in the vertical direction.

Next, it is determined whether there is the additional data to be allocated in step of S840. If it is determined that there is the additional data to be allocated, it is determined whether the data burst is allocated to the final symbol duration of the data region in step of S850. If the data burst is allocated to the final symbol duration of the data region, the allocation of the data bursts is re-started from the symbol at which the data region is started in step of S860. After that, if there is the data to be allocated, the data burst is allocated just before the symbol offset of the corresponding sector in step of S870, thereby completing the allocation of the data burst.

In step of S850, if the data burst is not allocated to the final symbol duration of the data region, the steps of S830 to S850 are repeated.

When all data burst allocation is completed through the aforementioned steps, or there is no additional data to be allocated in step of S840, it is determined whether the data bursts are allocated in the time-sequential order in step of S880. If the data bursts are not allocated in the time-sequential order, the MAP IEs corresponding to the data bursts in the MAP region and the packets corresponding to the data bursts are re-arranged in the time-sequential order in step of S890.

Although not shown in the aforementioned steps, the MAP message including the MAP IEs for the respective data bursts is generated and allocated into the MAP region of the downlink sub-frame during the step of allocating the respective data bursts. At this time, if there is the remaining region in the MAP region after completing the allocation of the MAP message, this remaining region is set as the shared region, and the data bursts for the MS with the higher SINR is allocated into the shared region.

In the modified embodiment of the present invention, the data region is divided by zone switch. Then, the first zone is set as the shared region, and the data bursts for the MS of the higher SINR is allocated into the shared region.

The aforementioned embodiment of the present invention discloses that the data bursts are firstly allocated into the segment region for each sector, and then the data bursts are allocated in the time-sequential order after the allocation of the data bursts for the corresponding segment region is completed.

However, the modified embodiment of the present invention discloses that the segment region to be allocated with the data bursts are controllably determined in consideration of the location of MS, instead of allocating the data bursts in the time-sequential order. Since these have been mentioned in the explanation about the MS location checking means, the detailed explanation thereof will be omitted.

### Second Embodiment

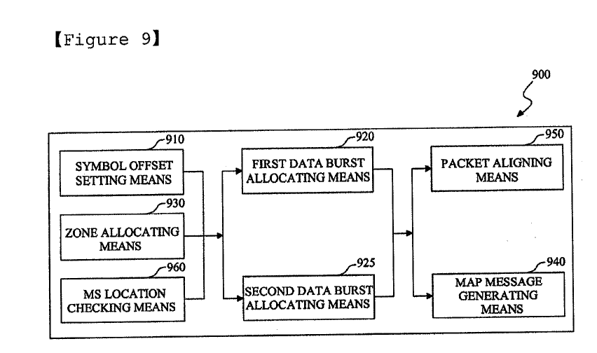

FIG. 9 is a block diagram schematically illustrating an apparatus for allocating data bursts according to the second embodiment of the present invention. The apparatus for allocating data bursts 900 according to the second embodiment of the present invention can allocate the data bursts in a vertical or horizontal direction. As shown in FIG. 9, the apparatus for allocating data bursts 900 includes a symbol offset setting means 910, a first data burst allocating means 920, a second data burst allocating means 925, a zone allocating means 930, a MAP message generating means 940, and a packet aligning means 950.

The symbol offset setting means 910 sets a symbol offset at which an allocation of data burst is started within a data region of a downlink sub-frame. The symbol offset setting means 910 according to the second embodiment of the present invention has a same function as the symbol offset setting means 310 according to the first embodiment of the present invention, whereby the detailed explanation about the symbol offset setting means 910 according to the second embodiment of the present invention will be omitted. The method for setting the symbol offset, shown in FIG. 4, according to the first embodiment of the present invention can be identically applied to the second embodiment of the present invention.

Next, the first data burst allocating means 920 allocates the data bursts into a segment region of each sector allocated based on the symbol offset for each sector. That is, the segment region is differently allocated for each sector. Thus, even though the allocation of data burst for each sector is started at the same time, it is possible to reduce interference among the sectors since the regions allocated with the data bursts are not overlapped with one another. At this time, the data burst size allocated by the first data burst allocating means 920 is determined in consideration of a size of the data to be transmitted or a channel state.

In one embodiment of the present invention, the first data burst allocating means 920 allocates the data bursts in the vertical direction. The vertical data burst allocation indicates that the data bursts are allocated in an increasing sub-channel direction within a predetermined symbol-duration, and then the data bursts are sequentially allocated in the increasing sub-channel direction from an initial sub-channel of the next symbol duration when the allocation of the data bursts are completed in the predetermined symbol duration.

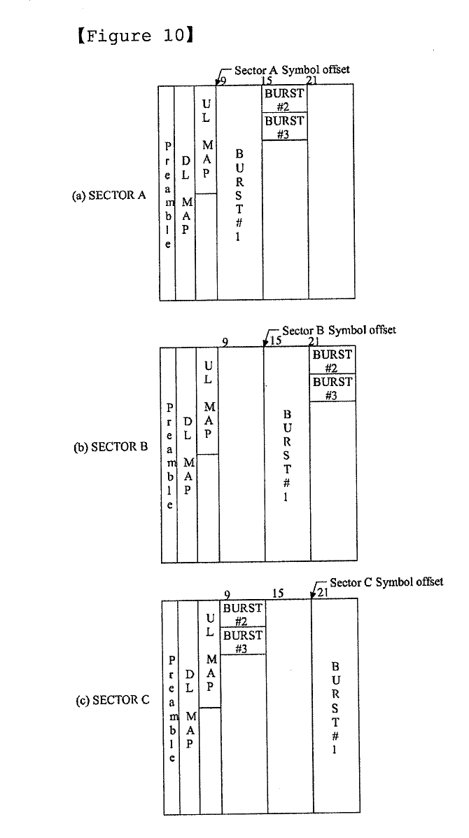

A procedure for allocating the data bursts by the first data burst allocating means 920 will be explained in detail. For example, in the example of FIG. 10, the symbol offset of sector A is the symbol 9, the symbol offset of sector B is the symbol 15, and the symbol offset of sector C is the symbol 21. Thus, as shown in FIG. 10, the first data burst allocating means 920 starts to vertically allocate the data burst #1 from the symbol 9 in case of the sector A, to vertically allocate the data burst #1 from the symbol 15 in case of the sector B, and to vertically allocate the data burst #1 from the symbol 21 in case of the sector C.

According to the present invention, the allocation of data bursts is started at the different region by each sector, thereby resulting in reduction of interference among the respective sectors.

Referring once again to FIG. 9, if the additional data to be allocated remains after completing the allocation of data bursts in the segment region allocated for each sector by the first data burst allocating means 920, the second data burst allocating means 925 additionally allocates the data bursts into the other segment region except the segment region allocated for each sector.

At this time, when additionally allocating the data burst, the second data burst allocating means 925 allocates the data bursts in the horizontal direction.

The horizontal data burst allocation indicates that the data bursts are allocated in the increasing symbol direction within a predetermined sub-channel duration, and then the data bursts are sequentially allocated in the increasing symbol index direction from an initial symbol of the next sub-channel duration when the allocation of the data bursts is completed in the predetermined sub-channel duration.

In the present invention, the data bursts are allocated in the horizontal direction within the segment region except for the segment region allocated for each sector. This can reduce interference of the neighboring sectors, because of permutation, even though the data bursts are simultaneously allocated to the overlapped regions of the neighboring sectors.

On allocation of the data bursts for each sector by the second data burst allocating means 925, if there is the remaining data to be allocated after completing the allocation of the data bursts to the final symbol duration of the data region, the second data burst allocating means 925 can re-allocate the data bursts into the region between the symbol at which the data region is started and the symbol offset for each sector.

A procedure for allocating the data bursts by the second data burst allocating means 925 will be explained in detail. For example, in the sector A of FIG. 10, if there is the remaining data to be allocated after the data burst #1 is vertically allocated into the segment region 0 (symbol 9 to symbol 14) by the first data burst allocating means 920, the data burst #2 and the data burst #3 are vertically allocated into the segment region 1 (symbol 15 to symbol 20) by the second data burst allocating means 925.

After that, if there is the data to be additionally allocated after completing the allocation of the data bursts in the segment region 1, the second data burst allocating means 925 allocates the remaining data burst into the segment region 2 (symbol 21 to symbol 26) in the horizontal direction.

Meanwhile, in the sector B, if there is the data to be additionally allocated after the data burst #1 is vertically allocated into the segment region 1 (symbol 15 to symbol 20) by the first data burst allocating means 920, the data burst #2 and the data burst #3 are horizontally allocated into the segment region 2 (symbol 21 to symbol 26) by the second data burst allocating means 925.

After that, if there is the data to be additionally allocated after completing the allocation of the data bursts in the segment region 2, the second data burst allocating means 925 allocates the remaining data bursts into the segment region 0 (symbol 9 to symbol 14) in the horizontal direction.

Finally, in the sector C, if there is the data to be additionally allocated after the data burst #1 is vertically allocated into the segment region 2 (symbol 21 to symbol 26) by the first data burst allocating means 920, the data burst #2 and the data burst #3 are horizontally allocated into the segment region 0 (symbol 9 to symbol 14) by the second data burst allocating means 925.

After that, if there is the data to be additionally allocated after completing the allocation of the data bursts in the segment region 0, the second data burst allocating means 925 allocates the remaining data bursts into the segment region 1 (symbol 15 to symbol 20) in the horizontal direction.

The order for allocating the data bursts for each sector and the allocation method have been explained with reference to FIG. 4.

In the sector A, the data bursts are allocated in the order of segment region 0, segment region 1, and segment region 2, wherein the segment region 0 is applied with the vertical data burst allocation scheme, and the segment region 1 and the segment region 2 are applied with the horizontal data burst allocation scheme.

In the sector B, the data bursts are allocated in the order of segment region 1, segment region 2, and segment region 0, wherein the segment region 1 is applied with the data burst allocation scheme, and the segment region 2 and the segment region 0 are applied with the horizontal data burst allocation scheme.

In the sector C, the data bursts are allocated in the order of segment region 2, segment region 0, and segment region 1, wherein the segment region 2 is applied with the vertical data burst allocation scheme, and the segment region 0 and the segment region 1 are applied with the horizontal data burst allocation scheme.

The aforementioned embodiment of the present invention discloses that the first burst allocating means 920 is separated from the second data burst allocating means 925, for convenience of the explanation. However, the first burst allocating means 920 and the second data burst allocating means 925 may be integrated into one means.

In the same manner as the data burst allocating means 320 according to the first embodiment of the present invention, if there is the remaining region after allocating the downlink and uplink MAP messages into the MAP region of the downlink sub-frame for each sector by the MAP message generating means 940, the first burst allocating means 920 and the second data burst allocating means 925 set the corresponding region as a shared region, and additionally allocates the data bursts into the shared region. Since this has been explained in the first embodiment of the present invention, the detailed explanation thereof will be omitted.

In the same manner as the first embodiment of the present invention, the apparatus for allocating data bursts 900 according to the second embodiment of the present invention further includes the zone allocating means 930, which sets the shared region with some of the data region instead of the MAP region. Since this has been explained in the zone allocation means 930 according to the first embodiment of the present invention, the detailed explanation thereof will be omitted.

Also, the MAP message generating means 940 generates the downlink MAP message and uplink MAP message, and allocates the generated DL-MAP and UL-MAP messages into the MAP region of the downlink sub-frame. The MAP message generating means 940 according to the second embodiment of the present invention have same function as the MAP message generating means 340 according to the first embodiment of the present invention, whereby the detailed explanation about the function of the MAP message generating means 940 according to the second embodiment of the present invention will be omitted.

In the same manner as the first embodiment of the present invention, the apparatus for allocating data bursts 900 according to the second embodiment of the present invention further includes an MS location checking means 960. After completing the allocation of the data bursts into the segment region allocated for each sector by the first data burst allocating means 920, the next segment region to be allocated with the data bursts may be controllably determined by the second first data burst allocating means 925 in consideration of the location of MS. The MS location checking means 960 in the second embodiment of the present invention has same function as the MS location checking means 360 in the first embodiment of the present invention, whereby the detailed explanation about the function of the MS location checking means 960 will be omitted.

In this case, the second data burst allocation means 925 determines the next segment region to be allocated with the data bursts in consideration of the MS location. A method for setting the region to be allocated with the data bursts in consideration of the MS location by the second data burst allocation means 925 is identical to that of the first embodiment of the present invention shown in FIG. 7, whereby the detailed explanation about the method will be omitted. The aforementioned embodiment of the present invention discloses that the apparatus for allocating data bursts is comprised of the plurality of separate means. However, these separate means may be integrated as one means such as a scheduler of BS.

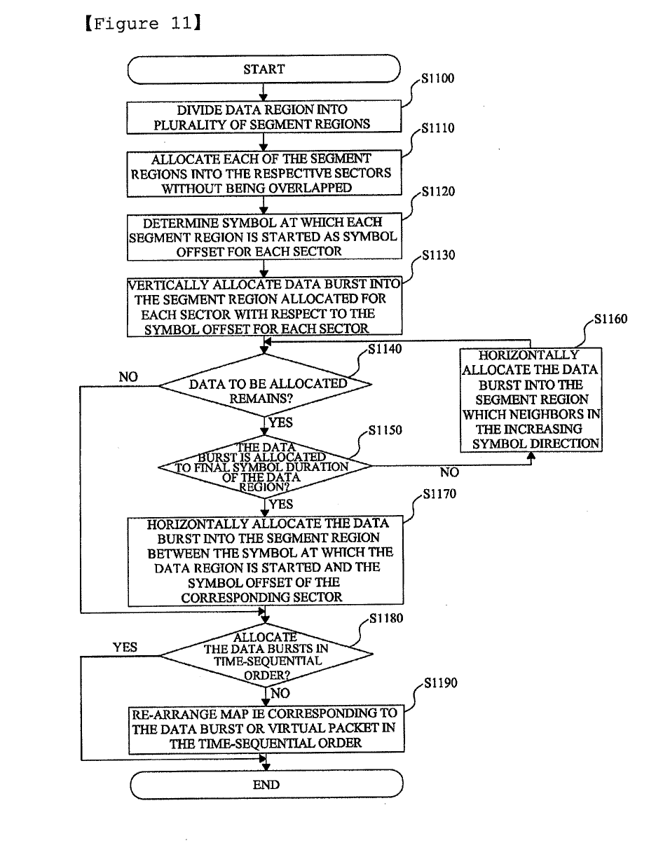

A detailed method for allocating data bursts according to the second embodiment of the present invention will be explained with reference to FIG. 11.

Among steps shown in FIG. 11, since the steps S1100 to S1150 are identical to the aforementioned steps S800 to S850 of FIG. 8, the detailed explanation about the steps S1100 to S1150 will be omitted.

Based on a determined result of the step S1150, if it is determined that the data bursts are not allocated to the final symbol duration of the data region, the data bursts are horizontally allocated into the segment region which neighbors to the segment region allocated for each sector in the increasing symbol direction in step of S1160, and the steps S1140 and S1150 are performed repetitively.

Based on a determined result of the step S1150, if it is determined that the data bursts are allocated to the final symbol duration of the data region, the data bursts are sequentially allocated in the horizontal direction into the segment regions between the symbol at which the data region is started and the symbol offset for each sector until there is no data to be allocated, in step of S1170.

When the allocation for all data bursts is completed through the aforementioned steps, or there is no more data to be allocated in step of S1140, it is determined whether the data bursts are allocated according to the time-sequential order in step of S1180. If the data bursts are not allocated according to the time-sequential order, the MAP IEs for the corresponding data bursts in the MAP region and the packets corresponding to the data bursts are re-arranged according to the time-sequential order in step of S1190.

Although not shown in the aforementioned steps, in the same manner as that of FIG. 8, the MAP message including the MAP IEs for the respective data bursts is generated and allocated into the MAP region of the downlink sub-frame during the step for allocating data bursts. At this time, if there is the remaining region after the allocation of the MAP message in the MAP region, the remaining region is set as the shared region, and the data bursts for the MS having the higher SINR is allocated into the shared region.

Also, the data region is divided by zone switch, wherein the first zone is set as the shared region, and the data bursts for the MS having the higher SINR is allocated into the shared region.

In the aforementioned embodiment of the present invention, the data bursts are firstly allocated into the segment region allocated for each sector, and then the data bursts are additionally allocated into the segment region which neighbors to the segment region allocated for each sector in the increasing symbol direction (in case of the final symbol duration of the data region, the data bursts are additionally allocated starting from the segment region located in the symbol at which the data region is started).

In the modified embodiment of the present invention, after completing the allocation of the data bursts in the segment region allocated for each sector, the next segment region to be allocated with the data bursts is controllably determined in consideration of the location of MS.

The aforementioned method for allocating data bursts can be embodied in type of program which can be performed through the use of various computer means. At this time, the program to perform the method for allocating data bursts is recorded in a computer-readable recording medium, for example, hard disc, CD-ROM, DVD, ROM, RAM, or flash memory.

It will be apparent to those skilled in the art that various modifications and variations can be made in the present invention without departing from the spirit or scope of the inventions.

For example, the second embodiment of the present invention discloses that the data bursts are allocated in the vertical direction into the segment region allocated for each sector. However, the modified embodiment of the present invention discloses that the data bursts may be allocated in the horizontal direction into the segment region allocated for each sector.

Thus, it should be understood that the aforementioned embodiments of the present invention are for purpose of illustration, and are not to be constructed as limitations of the invention. It is intended that the present invention covers the modifications and variations of this invention provided they come within the scope of the appended claims and their equivalents.

1. A method for allocating data bursts comprising:
dividing a data region of a downlink sub-frame for each of neighboring sectors into a plurality of segment regions, and allocating each of the segment regions into the respective sectors without being overlapped; and
allocating downlink data bursts for the respective sectors, wherein the allocation of downlink data bursts is sequentially started from the segment region allocated for each sector.

2. The method of claim 1, wherein the step for allocating the downlink data bursts is characterized by sequentially allocating the downlink data bursts in an increasing sub-channel direction within a predetermined symbol-duration.

3. The method of claim 1, wherein the symbol indicating a start of the data region and the number of symbols allocated into the data region are identically set in each sector.

4. The method of claim 1, wherein the number of segment regions is determined according to the number of neighboring sectors.

5. The method of claim 1, wherein the step for allocating the downlink data bursts is characterized by allocating the downlink data bursts into a region between the symbol indicating the start of the data region and a symbol indicating a start of the segment region allocated for each sector, if the downlink data bursts is allocated to the final symbol duration of the downlink sub-frame by each sector.

6. The method of claim 1, further comprising:
generating and allocating a downlink MAP message indicating the downlink data bursts and an uplink MAP message indicating an uplink data bursts in a MAP region of the downlink sub-frame.

7. The method of claim 1, wherein a region which remains in a MAP region of the downlink sub-frame after allocating a downlink MAP message and uplink MAP message is defined as a shared region, and the downlink data burst is additionally allocated into the shared region.

8. The method of claim 7, wherein the downlink data bursts allocated into the shared region are the downlink data bursts for an MS of a higher SINR.

9. The method of claim 1, further comprising re-arranging downlink MAP IEs of downlink MAP message for each sector or packets corresponding to the downlink data bursts in a time-sequential order, if the downlink data bursts for each sector are not allocated in the time-sequential order after the step for allocating the downlink data bursts.

10. The method of claim 1, further comprising checking a location of MS,
wherein, in the allocation of the downlink data bursts, if there is a request for the additional allocation of the downlink data bursts after completing the allocation of the downlink data bursts in the segment region allocated for each sector, the segment region to be additionally allocated with the downlink data bursts is determined in consideration of the location of MS and the downlink data bursts is additionally allocated into the determined segment region.

11. The method of claim 1, wherein the step for allocating the downlink data bursts further comprising defining a shared region in the data region by allocating an additional zone in the data region,
wherein the downlink data bursts for the MS of the higher SINR is allocated into the shared region.

12. The method of claim 1, wherein the step for allocating the downlink data bursts comprising:
firstly allocating the downlink data bursts into the segment region allocated by each sector; and
additionally allocating the downlink data bursts in an increasing symbol direction within the other segment region, sequentially, except for the segment region allocated by each sector, if there is a request for the additional allocation of the downlink data bursts after completing the allocation of the downlink data bursts in the segment region allocated by each sector.

13. The method of claim 12, wherein the step for firstly allocating the downlink data bursts is characterized by sequentially allocating downlink data bursts in the increasing sub-channel direction or increasing symbol direction.

14. A method for allocating data bursts comprising:
differently setting a start symbol offset for allocation of the downlink data bursts in a downlink sub-frame for each of neighboring sectors by each sector; and
allocating the downlink data bursts for the respective sectors based on the start symbol offset differently set by each sector.

15. The method of claim 14, wherein the step for allocating the downlink data bursts is characterized by sequentially allocating the downlink data bursts in an increasing sub-channel direction within a predetermined symbol-duration with respect to the start symbol offset.

16. The method of claim 14, wherein the step for allocating the downlink data bursts comprising:
firstly allocating the downlink data bursts into a prior-allocation region including a predetermined number of symbols from the start symbol offset allocated by each sector; and
additionally allocating the downlink data bursts in an increasing symbol direction within the other regions, sequentially, except for the prior-allocation region if there is a request for an additional allocation of the downlink data bursts after completing the prior allocation of the downlink data burst.

17. The method of claim 16, wherein the step for firstly allocating the downlink data bursts into the prior-allocation region is characterized that the number of symbols included in the prior-allocation region is calculated by a ratio of the number of neighboring sectors to the total number of symbols to be allocated with the downlink data bursts.

18. The method of claim 14, wherein, if the downlink data bursts for each sector are not allocated in a time-sequential order, downlink MAP IEs of a downlink MAP message of each sector or packets corresponding to the downlink data bursts is re-arranged in the time-sequential order.

19. An apparatus for allocating data bursts comprising:
a means for differently setting a symbol offset to indicate a start of allocation of downlink data bursts in a data region of a downlink sub-frame for each of neighboring sectors by each sector; and
a means for allocating the downlink data bursts for the respective sectors based on the start symbol offset differently set by each sector.

20. The apparatus of claim 19, wherein the means for allocating the downlink data bursts sequentially allocates the downlink data bursts in an increasing sub-channel direction within a predetermined symbol-duration.

21. The apparatus of claim 19, wherein the means for differently setting the symbol offset identically sets the symbol indicating a start of the data region, and the number of symbols allocated into the data region in each sector.

22. The apparatus of claim 19, wherein the means for allocating the downlink data bursts allocates the downlink data bursts into a region between the symbol indicating the start of the data region and the start symbol offset for each sector if the downlink data bursts are allocated to the final symbol of the downlink sub-frame by each sector.

23. The apparatus of claim 19, further comprising
a means for defining a shared region in the data region by allocating an additional zone in the data region,
wherein the means for allocating the downlink data bursts allocates the downlink data bursts for an MS of a higher SINR into the shared region.

24. The apparatus of claim 19, further comprising:
a means for re-arranging data packets corresponding to the downlink data burst in a time-sequential order if the downlink data bursts for each sector are not allocated in the time-sequential order.

25. The apparatus of claim 19, wherein the means for allocating the downlink data bursts comprising:
a means for firstly allocating the downlink data bursts into a prior-allocation region including a predetermined number of symbols from the start symbol offset allocated by each sector; and
a means for additionally allocating the downlink data bursts into the other regions, sequentially, except for the prior-allocation region if there is a request for an additional allocation of the downlink data bursts after firstly allocating the downlink data bursts.

26. The apparatus of claim 25, wherein the number of symbols included in the prior-allocation region is calculated by a ratio of the number of neighboring sectors to the total number of symbols to be allocated with the downlink data bursts.

27. A method for allocating data bursts comprising:
setting start symbol offset of a first sector which is different from start symbol offsets of at least two neighbor second sectors in a data burst region of a downlink sub-frame of the first sector; and
allocating data bursts into a vertical burst allocation region defined by the number of first OFDMA symbols from the start symbol offset for the first sector.

28. The method of claim 27, further comprising:
allocating additional data bursts into a horizontal burst allocation region defined by the number of second OFDMA symbols within the other region of the data burst region of the downlink sub-frame except for the vertical burst allocation region.

29. The method of claim 27, wherein the downlink sub-frame includes a shared region into which data bursts is allocated for all sectors.
